(19) United States
(12) Patent Application Publication
(10) Pub. No.: US 2009/0002235 A1
(43) Pub. Date: Jan. 1, 2009

(54) Radio Communication System, Transmission Apparatus, Transmission Method, Program and Recording Medium

(75) Inventor: Takumi Ito, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/816,876

(22) PCT Filed: Feb. 16, 2006
(86) PCT No.: PCT/JP2006/302695

§ 371 Date: Sep. 10, 2007

(30) Foreign Application Priority Data
Mar. 14, 2005 (JP) 2005-071499

(51) Int. Cl. H01Q 3/00

(52) U.S. Cl. 342/368

(57) ABSTRACT

Although the beam forming is quite a good scheme, if there exist particularly a plurality of users, the characteristic deterioration occurs in an associated communication line due to the tight radio resource on the reverse line and delay in the transmission time caused by the feedback of information exceeding the required information. The transmitter 1 in a radio communication system receives signals by the antennas 13-1 to 13-M and the duplexers 14-1 to 14-M, extracts user's profile information by the transmission signal controller 12, determines in a unified manner a radio resource amount and its assignment as well as the application or non-application of the beam forming, generates by the transmission signal generator 11 transmission signals using user's transmission data according to the resource distribution and the application or non-application of the beam forming thus determined, and transmits the signals by use of the duplexers 14-1 to 14-M and the antennas 13-1 to 13-M.

### TECHNICAL FIELD

The present invention pertains to a radio communication system, and in particular, to a transmission apparatus including a plurality of antennas.

### RELATED ART

As described in non-patent document 1, in a Multi-Input Multi-Output (MIMO) system in which a transmitter-receiver uses a plurality of antennas, signal processing are executed employing channel information in a receiver and signal processing using the same channel information also in a transmitter, and hence considerable characteristic improvement is expected. Among these systems, a scheme in which the channel information between the transmitter-receivers is represented by a matrix and the transmitter conducts transmission beam forming by use of decomposition of the matrix is highest in the characteristic. This is because transmission parameters can be controlled, for a plurality of independent propagation paths formed by the signal processing in the transmitter-receiver, according to reception quality of each transmission path. In this situation, processing necessary for the receiver to form independent propagation paths is linear synthesis processing which uses a channel matrix and which is quite simple.

On the other hand, if the transmitter does not adopt the channel information, signals sent from a plurality of transmission antennas interfere with each other when they are received by the receiver. In this operation, the characteristic remarkably depends on the reception scheme; in general, a more favorable characteristic is obtained by a receiver requires more complex processing. However, even in a case employing the maximum likelihood detection method for which the most favorable characteristic is expected, the characteristic is deteriorated when compared with the scheme in which the signal processing is carried out using the same channel information by the transmitter-receiver.

### <Article>

Non-patent document 1 Takeo OHGANE, Toshihiko NISHIMURA, and Yasutaka OGAWA “Applications of Space Division Multiplexing and Those Performance in a MIMO Channel”, IEICE, Proceedings in Japanese, Vol. J87-B, No. 9, pp. 1162-1173.

### DISCLOSURE OF THE INVENTION

### Problems to be Solved by the Invention

The first problem is that if the beam forming is applied to a plurality of users, the radio resources of reverse lines become tight. This is because it is necessary to feed back the channel information required for the beam forming via the reverse lines and the radio resource amount required for the feedback increases especially if there exist a plurality of users.

The second problem is that the transmission characteristic of the user to whom the beam forming is applied deteriorates. This is because when a certain period of time passes from when the transmitter obtains the channel information to when the actual transmission is carried out, the channel information differs from an actual channel.

A first object of the present invention is to provide a radio communication system and the like wherein in an environment where a plurality of users exist, an amount of radio resources to be allocated to each of N users (indicating there are N users. N is an integer equal to or more than two) and assignment thereof as well as application or non-application of beam forming are efficiently determined.

A second object of the present invention is to provide a radio communication system and the like wherein assignment of radio resources is determined not to deteriorate the reception quality of the user to whom the beam forming is applied.

A third object of the present invention is to provide a radio communication system and the like wherein application or non-application of the beam forming is determined by efficiently using resources of the reverse lines.

### Means for Solving the Problem

To solve the problems, in a first radio communication system provided by the present invention, signals are transmitted from a transmitter including an M antennas, transmission signal control means to determine an amount of radio resources to be allocated to each of N users and assignment thereof as well as application or non-application of beam forming, and transmission signal generator means for producing transmission signals using transmission data. As a result, the first to third objects can be achieved.

In a second radio communication system provided by the present invention, the transmission signal control means included in the first radio communication system first determines the amount of radio resources to be allocated to each of the N users, the application or non-application of the beam forming is determined for all users to whom radio resources are allocated, and the assignment of radio resources are determined by use of the result of the determination. It is resultantly possible to achieve the first and second objects.

In a third radio communication system provided by the present invention, the transmission signal control means included in the first radio communication system provisionally determines the application or non-application of the beam forming for all users, and the amount of radio resources to be allocated to each of N users and the assignment thereof as well as application or non-application of beam forming are determined by use of the result of the determination Resultantly, the first and second objects can be achieved.

In a fourth radio communication system provided by the present invention, the transmission signal control means included in the first radio communication system primarily determines applicability of the beam forming according to particular information, and a request is issued only to the users for whom the primary determination is conducted, for information requiring the feedback. It is resultantly possible to achieve the first to third objects.

### EFFECTS OF THE INVENTION

A first advantage is that the application or non-application of the beam forming and the amount of radio resources to be distributed to each user and assignment thereof can be efficiently determined. This is because these items are determined in an integrated manner, in accordance with the present invention, on the basis of profile information of each user.

A second advantage is mitigation of the characteristic deterioration for the user for whom the beam forming is applied. This is because the amount of radio resources and assignment thereof and the application or non-application of the beam forming are determined such that the transmission time of the user to whom the beam forming is applied is earlier than that of the user to whom the beam forming is not applied.

A third advantage is that by efficiently using radio resources of reverse lines, the application or non-application of the beam forming and the amount of radio resources to be distributed to each user and assignment thereof can be determined. This is because the application or non-application of the beam forming is determined using known information and then the feedback is obtained for the users requiring information.

### DESCRIPTION OF EXEMPLARY EMBODIMENTS

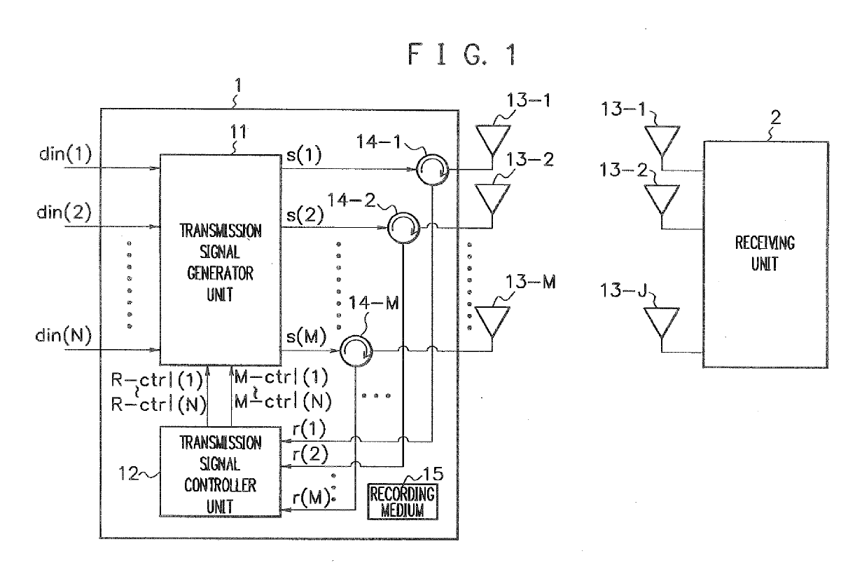

Next, referring to drawings, description will be given in detail of exemplary embodiments of a radio communication system and the like of the present invention. FIG. 1 is a block diagram showing a configuration of a radio communication system.

Referring to FIG. 1, the radio communication system in a first exemplary embodiment includes a transmitter 1 including M antennas 13-1 to 13M (M is an integer equal to or more than two) and a receiver 2 including J antennas 13-1 to 13-J (J is an integer equal to or more than one).

The transmitter 1 includes duplexers 14-1 to 14-M, transmission signal generator means 11, transmission signal control means 12, and a recording medium 15.

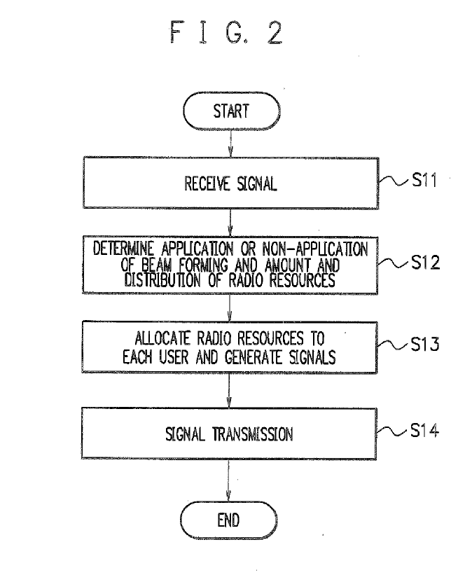

FIG. 2 is a flowchart showing operation of the radio communication system Processing shown in FIG. 2 is realized when the transmitter 1 executes a program stored in the recording medium 15.

Referring to FIGS. 1 and 2, description will be given of the processing in the radio communication system.

The duplexers 14-1 to 14-M and antennas 13-1 to 13-M receive signals (received signals are referred to as r(1) to r(M); step S11). The transmission signal control means 12 extracts profile information from the received signals r(1) to r(M), determines the amount of radio resources to be allocated to each of the N users and assignment thereof and further determines whether the beam forming is applied thereto or not, and produces radio resource control signals R-ctrl(1) to R-ctrl(N) and transmission mode control signals M-ctrl(1) to M-ctrl(N) (step S12). The transmission signal generator unit 11 creates transmission signals s(1) to s(M) using as inputs thereto transmission data items din(1) to din(N), radio resource control signals, and transmission mode control signals and then outputs the transmission signals therefrom (step S13). The duplexers 14-1 to 14-M and antennas 13-1 to 13-M sends the transmission signals (step S14). Resultantly, it is possible to efficiently determine the amount of radio resources to be allocated to each user and assignment thereof and the application or non-application of the beam forming thereto.

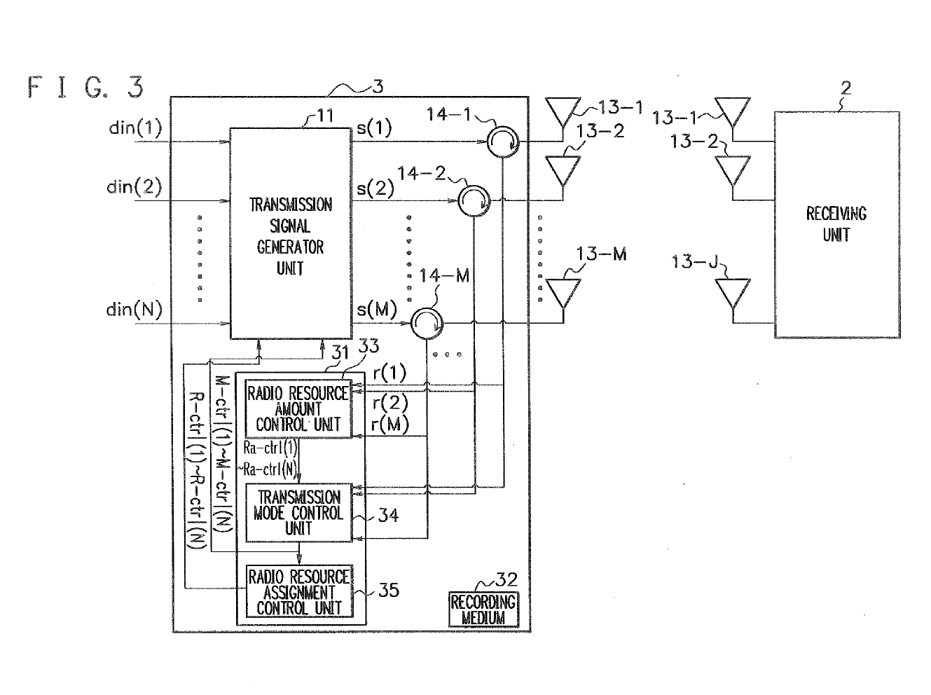

Subsequently, referring to the drawings, description will be given in detail of a second exemplary embodiment of the radio communication system. FIG. 3 is a block diagram showing structure of the radio communication system.

The second embodiment is similar in structure to the radio communication system in the first exemplary embodiment of the present invention excepting that a transmitter 3 is disposed in place of the transmitter 1.

Referring to FIG. 3, the transmitter 3 in the second embodiment includes duplexers 14-1 to 14-M, a transmission signal generator module 11, a transmission signal control module 31, and a recording medium 32. The signal control module 31 includes a radio resource amount control unit 33, a transmission mode control unit 34, and a radio resource assignment control unit 35.

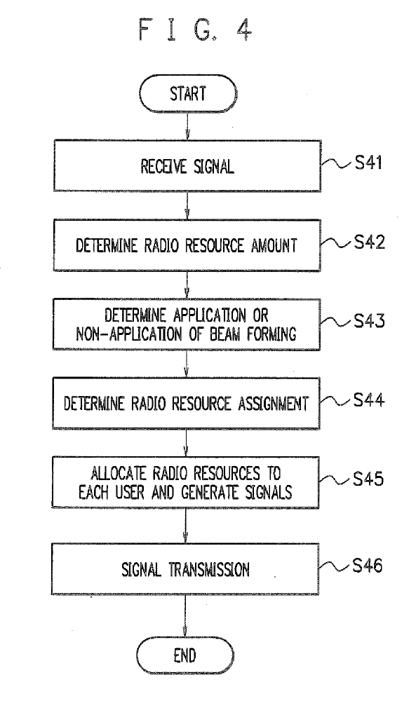

FIG. 4 is a flowchart showing operation of the radio communication system in the second embodiment. Processing shown in FIG. 4 is realized when the transmitter 3 executes a program stored in the recording medium 32 shown in FIG. 3.

Referring to FIGS. 3 and 4, description will be given of the radio communication system.

The duplexers 14-1 to 14-M and antennas 13-1 to 13-M receive signals (step S41). The radio resource amount control unit 33 extracts profile information to determine the radio resource amount to be allocated to each of the N users and produces radio resource amount control signals Ra-ctrl(1) to Ra-ctrl(N) (step S42). Next, the transmission mode control unit 34 determines the application or non-application of the beam forming for the user to whom the radio resources are allocated and then creates and outputs transmission mode control signals M-ctrl (1) to M-ctrl (N) (step S43). Subsequently, the radio resource assignment control unit 35 determines the assignment of radio resources, by use of the transmission mode control signals and the radio resource amount control signals as inputs thereto, such that the signal transmission time of the user to whom the beam forming is applied is earlier than that of the user to whom the beam forming is not applied and then generates and outputs radio resource control signals R-ctrl(1) to R-ctrl(N) (step S44). Thereafter, on the basis of the radio resource control signal and the transmission mode control signal, the transmission signal generator 11 allocates radio resources to each of the N users and creates transmission signals (step S45). The duplexers 14-1 to 14-M and antennas 13-1 to 13-M send the transmission signals (step S46).

By making the signal transmission time of the user to whom the beam forming is applied be earlier as above, occurrence of the difference between the channel information employed for the beam forming and the actual channel is suppressed, and it is hence possible to prevent deterioration in the transmission characteristic for the associated users.

Incidentally, although the radio resource amount controller 33 and the transmission mode controller 34 extract profile information from the respective reception signals, a configuration in which a profile extraction unit is disposed to extract profile information such that the resource amount controller 33 and the mode controller 34 receive as inputs thereto the profile information from the profile extraction unit is also included in the present embodiment.

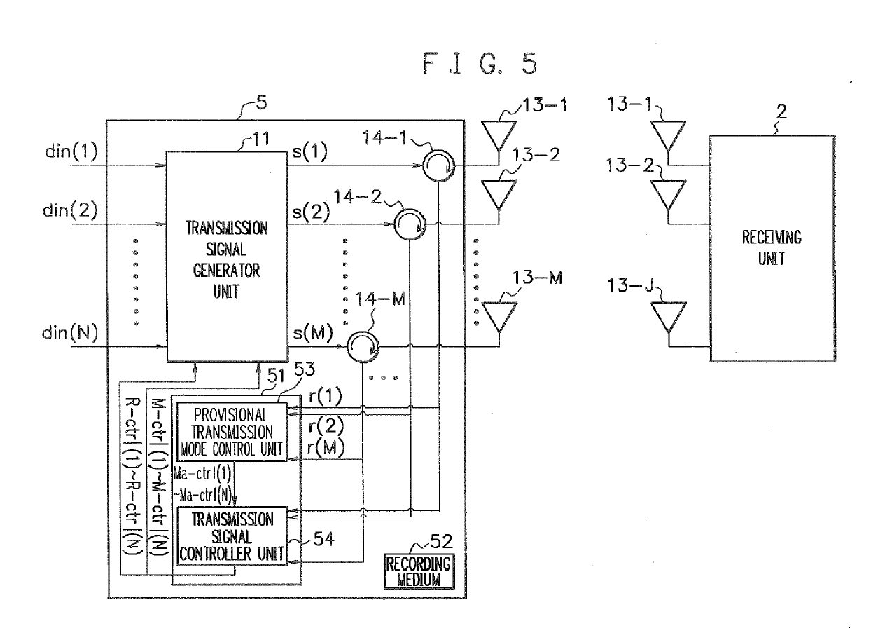

Next, referring to the drawings, description will be given in detail of a third exemplary embodiment of the radio communication system of the present invention. FIG. 5 is a block diagram showing structure of the third embodiment of the radio communication system. The third embodiment is similar in the configuration to the radio communication system in the first exemplary embodiment excepting that a transmitter 5 is arranged in place of the transmitter 1.

Referring to FIG. 5, the transmitter 5 in the third embodiment of the wireless communication system includes duplexers 14-1 to 14-M, a transmission signal generator unit 11, a transmission signal control unit 51, and a recording medium 52. The transmission signal controller 51 includes a provisional transmission mode control module 53 and a transmission signal control module 54.

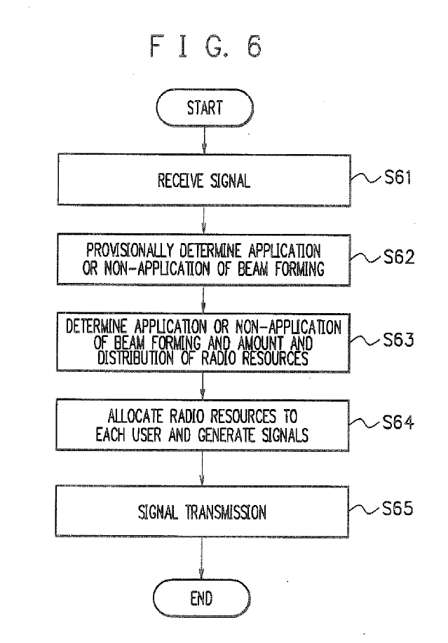

FIG. 6 is a flowchart showing operation of the radio communication system in the third embodiment. Processing shown in FIG. 6 is accomplished when the transmitter 5 executes a program stored in the recording medium 52 shown in FIG. 5.

Referring to FIGS. 5 and 6, description will be given of the radio communication system in the third embodiment.

The duplexers 14-1 to 14-M and antennas 13-1 to 13-M receive signals (step S61). The transmission mode control unit 53 receives a reception signal as an input thereto, extracts profile information from the reception signal, provisionally determines the application or non-application of the beam forming for all users, and then creates and outputs transmission mode control signals M-ctrl (1) to M-ctrl (N) (step S62). Next, the transmission signal controller 54 receives the reception signals and the transmission mode control signals as inputs thereto, extracts profile information from the reception signal, determines the radio resource amount to be allocated to each of the N users and the assignment thereof and the application or non-application of the beam forming, and creates and outputs the radio resource control signals R-ctrl(1) to R-ctrl(N) and the transmission mode control signals M-ctrl (1) to M-ctrl (N) (step S63). Subsequently, on the basis of the radio resource control signals and the transmission mode control signals, the transmission signal generator 11 produces and outputs transmission signals using the transmission data (step S64). The duplexers 14-1 to 14-M and antennas 13-1 to 13-M send the transmission signals (step S65).

As above, by determining, after the provisional determination of the application or non-application of the beam forming for all users, the radio resource amount to be allocated to each of the N users and the assignment thereof and the application or non-application of the beam forming are determined; it is therefore possible to preferentially allocate radio resources to the users to whom the beam forming is highly likely to be allocated, and hence the system can efficiently use the beam forming with a high transmission characteristic.

Incidentally, although the provisional transmission mode control module 53 and the transmission signal control module 54 extract the profile information from the respective reception signals, a configuration in which a profile extraction module is arranged to extract profile information such that the mode controller 53 and the transmission signal controller 54 receive as inputs thereto the profile information from the profile extraction unit is also included in the present embodiment.

Next, description will be given of concrete examples of the invention associated with the exemplary embodiments.

### Example 1

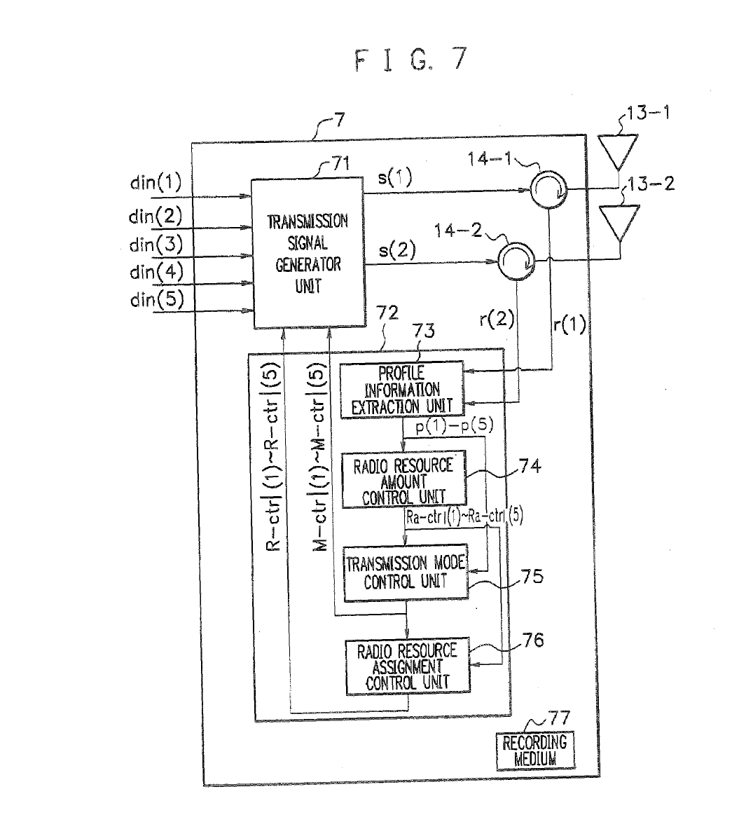

FIG. 7 is a block diagram showing a configuration of a transmitter of a first example of the present invention.

It is assumed in this example that there exist five users and the transmitter includes two antennas to conduct a total of 100 Megabits per second (Mbps) transmission using 5 Mbps Binary Phase Shift Keying (BPSK) signals in Time Division Multiple Access (TDMA). It is also assumed that each user has a receiver 2 including two antennas. However, these are only premises for explanation and hence do not restrict any example of the present invention.

Referring to FIG. 7, the transmitter 7 in the first example of the present invention includes two antennas 13-1 and 13-2, two duplexers and 14-2 to conduct a changeover operation between transmission and reception, a transmission signal control unit 72, a transmission signal generator unit 71, and a recording medium 77.

The transmission signal controller 72 includes a profile information extractor module 73, a radio resource amount control module 74, a transmission mode control module 75, and a radio resource assignment control module 76.

The antennas 13-1 and 13-2 and duplexers 14-1 and 14-2 receive signals from five users. The transmission signal controller 72 determines, by use of reception signals as inputs thereto, the radio resource amount to be allocated to each of the five users and the assignment thereof as well as the application or non-application of the beam forming for each of the five users, and produces the radio resource control signals R-ctrl(1) to R-ctrl(5) and the transmission mode control signals M-ctrl(1) to M-ctrl(5). The transmission signal generator 71 allocates radio resources to each user and produces transmission signals by use of transmission data items din(1) to din(5) of the five users, the resource control signals R-ctrl(1) to R-ctrl(5), and the mode control signals M-ctrl(1) to M-ctrl(5) as inputs thereto and then outputs transmission signals s(1) and s(2).

Subsequently, the transmission signal controller 72 will be described in detail.

The profile information extractor module 73 extracts profile information items p(1) to p(5) of the five users from the reception signals. Here, p(k) represents a profile information item of the k-th user and is information indicating the required rate and the channel variation speed of the user. Assume now that the profile information items p(1) to p(5) of the five users are p(1)=[60 Mbps,2 Hz], p(2)=[40 Mbps,10 Hz], p(3)=[30 Mbps,10 Hz], p(4) [20 Mbps,3 z], and p(5)=[10 Mbps,5 Hz].

The radio resource assignment control module 76 allocates radio resources preferentially to users having a higher required rate. As a result, 50 Mbps is allocated to the first user, 40 Mbps is allocated to the second user, 0 Mbps is allocated to the third and fourth users, and 10 Mbps is allocated to the fifth user, and the radio resource amount control signals are produced as Ra-ctrl(1)=[50 Mbps], Ra-ctrl(2)=[40 Mbps], Ra-ctrl(3)=[0], Ra-ctrl(4)=[0], and Ra-ctrl(5)=[10 Mbps]. The transmission mode control module 75 determines the application or non-application of the beam forming to each user by use of the profile information items and the radio resource amount control signals as inputs thereto. The transmission mode controller 75 applies the beam forming to users whose channel variation speed is equal to or less than five herz and does not apply the beam forming to users whose channel variation speed exceeds five herz. Resultantly, the transmission mode control signals are M-ctrl(1)=[BF], M-ctrl(2)=[N-BF], M-ctrl(3)=[N-BF], M-ctrl(4)=[BF], and M-ctrl(5)=[BF] By use of the radio resource amount control signals and the transmission mode control signals as input thereto, the mode controller 75 determines the assignment of radio resources to create the radio resource control signals such that the transmission points time of the first and fifth users to which the beam forming is applied is earlier than the transmission point of time of the second user to which the beam forming is not applied and the transmission point of time of the fifth user having a higher channel variation in the users to which the beam forming is applied is earlier than that of the first user. As a result, the radio resource control signals are R-ctrl(1)=[50 Mbps,#2], R-ctrl(2)=[40 Mbps,#3], R-ctrl(3)=[0,0], R-ctrl(4)=[0,0], and R-ctrl(5)=[10 Mbps,#1]. Here, #k indicates an order of transmission time, and the transmission signal of the user of #1 is transmitted at the earliest point of time.

By use of the radio resource control signals, the transmission mode control signals, and the transmission data items as inputs thereto, the transmission signal generator 71 creates transmission signals of the first, second, and fifth users to whom radio resources are allocated. According to the transmission points of time, the processing is executed beginning at the fifth user. Since the radio resource allocated to the fifth user is 10 Mbps, it is only necessary to produce two 5 Mbps BPSK symbols. Here, the created BPSK symbols are represented as d5-1 and d5-2. Subsequently, a singular value decomposition is carried out employing the channel matrix H(5) generated using the channel information of the fifth user. This is written as H(5)=U(5)D(5)V^{H}(5). Next, the beam forming is performed by use of the V(5) matrix and time-series signals to produce transmission signals. Assume now that the V(5) matrix is a two by two matrix and its elements are v5-11, v5-12, v5-21, and v5-22. In this situation, the time series of the transmission signals s(1) and s(2) are created through the beam forming as s(1)-1=v5-11d5-1+v5-12d5-2 and s(2)-1=v5-21d5-1+v5-22d5-2.

Next, the transmission signal for the first user is produced through the beam forming in the same way as for the fifth user. Since the radio resource allocated to the first user is 50 Mbps, it is only necessary to generate ten 5 Mbps BPSK symbols. The obtained symbols are d1-1, d1-2, d1-3, . . . , and d1-10. Subsequently, as in the case of the fifth user, by use of the V(i) matrix attained by conducting the singular value decomposition on the channel matrix H(1) of the first user, the transmission signals s(1)-2, s(2)-2 to s(1)-6, and s(2)-6 are created as s(1)-2=v1-11d1-1+v1-12d1-2, s(2)-2=v1-21-d11-+v1-22d1-2, s(1)-3 v1-11d1-3+v1-13d1-4, s(2)-3=v1-21d1-3+v1-22d1-4, . . . , s(1)-6=v1-11d1-9+v1-12d1-10, and s(2)-6=v1-21d1-9+v1-22d1-10.

Next, since the beam forming is not applied to the second user, the transmission signals are generated without applying the beam forming. The radio resource allocated to the second user is 40 Mbps, and hence eight BPSK symbols d2-1, d2-2, . . . , d2-8 are produced. By using these symbols, the transmission signals s(1)-7, s(2)-7 to s(1)-10, and s(2)-10 are created as s(1)-7=d2-1, s(2)-7=d2-2, s(1)-8=d2-3, s(2)-8=d2-4, . . . , s(1)-10=d2-7, and s(2)-10=d2-8. The transmission signal generator 71 outputs the transmission signals s(1)-1 to s(1)-10 and s(2)-1 to s(2)-10 respectively to the antennas 13-1 and 13-2.

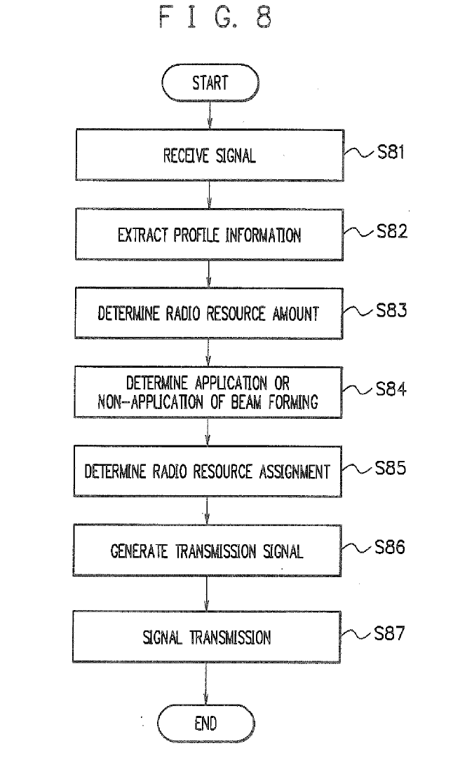

FIG. 8 is a flowchart showing transmission processing of the transmitter 1 according to the first example of the present invention. Referring to FIGS. 7 and 8, description will be given of the transmission processing according to the first example of the present invention. Incidentally, the processing shown in FIG. 8 is realized when the transmitter 7 executes a program in the recording medium 79 of FIG. 7.

The two antennas 13-1 and 13-2 receive signals from a receiver (step s81). The profile information extraction unit 73 extracts profile information items of five users and generates and outputs profile information items p(1) to p(5) (step S82). The radio resource amount controller 74 preferentially selects users with a higher required rate and allocates 50 Mbps to the first user, 40 Mbps to the second user, and 10 Mbps to the fifth user such that the total transmission rate is equal to or less than 100 Mbps, and sets the radio resources allocated to the third and fourth users to zero to output the results as the radio resource amount control signals R-ctrl(1) to R-ctrl(5) (step S83). The transmission mode controller 75 determines the application or non-application of the beam forming for each user and applies the beam forming to users whose channel variation speed is equal to or less than five herz, namely, the first, third, fourth, and fifth users. The mode controller 75 produces the results as transmission mode control signals (step S84). The radio resource assignment controller 76 controls operation such that the transmission points of time of the first and fifth users to whom the beam forming is applied and who are selected from the first, second, and fifth users to whom the radio resources are allocated are earlier than that of the second user to whom the beam forming is not applied and the transmission point of time of users having a higher channel variation speed is earlier among the users to whom the beam forming is applied. As a result, the radio resource control signals are created to transmit signals in an order of the fifth, first, and second users (step S85). By use of the radio resource control signals and the transmission mode control signals as inputs thereto, the transmission signal generator 71 creates and outputs transmission signals using the transmission data items of the first, second, and fifth users to whom radio resources are allocated, according to the radio resource control signals and the transmission mode control signals (step S86). The duplexers 14-1 and 14-2 and the antennas 13-1 and 13-2 deliver the transmission signals (step S87).

As described for the example, a larger amount is allocated to a user requiring a higher transmission rate and the application or non-application of the beam forming and the transmission order are determined according to the channel variation, and hence efficient resource distribution and determination of the transmission mode are conducted for each user.

Although the required transmission rate and the channel variation speed are adopted as the profile information in this example, this is only a premise for explanation and does not restrict the present invention. Additionally, although the beam forming and the space multiplexing using the singular value decomposition are employed as an example of the application or non-application of the beam forming, this is also a premise for explanation and does not restrict the present invention.

### Example 2

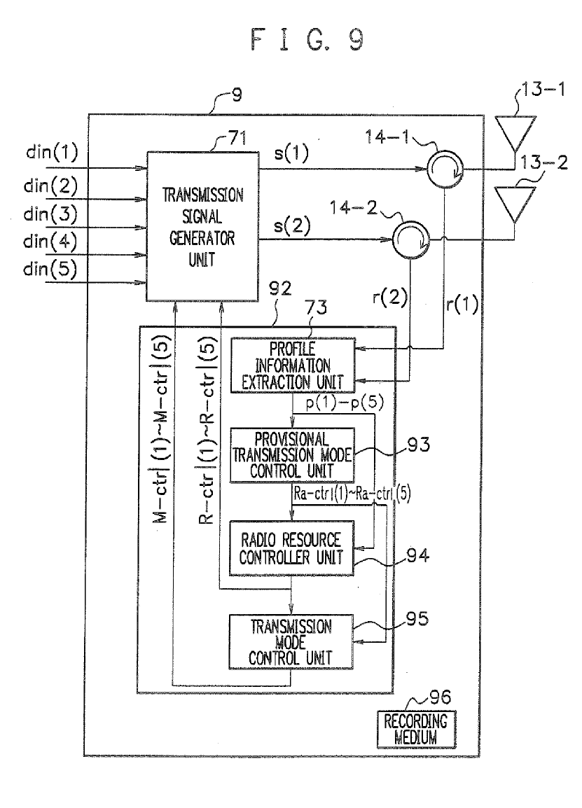

FIG. 9 is a block diagram showing a configuration of a transmitter according to a second example of the present invention.

It is assumed in this example that there exist five users and the transmitter includes two antennas and employs Orthogonal Frequency Division Multiplex (OFDM) of subcarrier 50 in which one Mbps transmission is possible by one subcarrier.

Referring to FIG. 9, the transmitter 9 in the second example of the present invention includes two antennas 13-1 and 13-2, two duplexers 14-1 and 14-2 to conduct a change-over operation between transmission and reception, a transmission signal generator unit 71, and a transmission signal control unit 92.

The transmission signal controller 92 includes a profile information extractor module 73, a provisional transmission mode control module 93, a radio resource control module 94, and a transmission mode control module 95.

The second example of the present invention differs from the first example in the configuration and operation of the transmission signal controller 92 and the operation of the transmission signal generator 71, and hence description will be given of the difference.

Assume now that the profile information items are the required rate, the channel variation speed, and the radio resource amount of the reverse line required for the feedback of channel information of respective users and are p(1)=[50 Mbps,10 Hz,512 kbps], p(2)=[40 Mbps,30 Hz,512 kbps], p(3)=[30 Mbps, Hz,512 kbps], p(4)=[20 Mbps,4 Hz,256 kbps], and p(5)=[10 Mbps,22 Hz,256 kbps].

Using the profile information as an input thereto, the provisional transmission mode controller 93 provisionally determines the application or non-application of the beam forming on the basis of the channel variation speed. If the criterion to apply the beam forming is a channel variation equal to or less than 12 Hz, the beam forming is applied to the users other than the second user, and the provisional transmission mode control signals are Ma-ctrl(1)=[BF], Ma-ctrl(2)=[N-BF], Ma-ctrl(3)=[BF], Ma-ctrl(4)=[BF], and Ma-ctrl(5)=[BF].

The radio resource controller 94 determines, by use of the profile information and the provisional transmission mode controller 93, the radio resource amounts to be assigned to the respective users and the assignment thereof. The resource controller 94 preferentially selects users to whom the beam forming is applicable, and particularly, the resource controller 94 preferentially allocates radio resources to users having a higher required rate. As a result, 50 Mbps is allocated to the first user, 30 Mbps is allocated to the third user, and 20 Mbps is allocated to the fourth user. Therefore, the radio resource control signals are R=ctrl(1)=[50 Mbps], R-ctrl(2)=[0], R-ctrl(3)=[30 Mbps], R-ctrl(4)=[20 Mbps], and R-ctrl(5)=[0]. Next, using the radio resource control signals and the profile information as inputs thereto, the mode controller 95 determines the application or non-application of the beam forming for each user. Assume now that the results of the application or non-application determined by the provisional transmission mode controller 93 are used without modification. Then, the beam forming is applied to the users other than the second user, and the transmission mode control signals are M-ctrl(1)=[BF], M-ctrl(2)=[N-BF], M-ctrl(3)=[BF], M-ctrl(4)=[BF], and M-ctrl(5)=[BF].

The transmission signal generator 71 produces transmission signals using the radio resource control signals and the transmission mode control signals as inputs thereto. The signal generator 71 prepares two OFDM symbols and allocates, for each of the symbols, 25 subcarriers to the first user, 15 subcarriers to the third user, and ten subcarriers to the fourth user. That is, for one of the OFDM signal, the allocation is conducted as f(1)=din(1)-1, f(2)=din(1)-3, . . . , f(25)=din(1)-49, f(26)=din(3)-1, f(27)=din(3)-3, . . . , f(40)=din(3)-29, f(41)=din(4)-1, f(42)=din(4)-3, . . . , f(50)=din(4)-19. For the other one of the OFDM signals, the allocation is conducted as g(1)=din(1)-2, g(2)=din(1)-4, . . . , g(25)=din(1)-50, g(26)=din(3)-2, g(27)=din(3)-4, . . . , g(40)=din(3)-30, g(41)=din(4)-2, g(42)=din(4)-4, . . . , g(50)=din(4)-20. Here, f(k) and g(k) represent the k-th subcarriers for the two OFDM signals.

Next, the beam forming is carried out by use of the channel matrices of the first, third, and fourth users. Assume that the singular value decomposition of the channel matrix corresponding to the k-th subcarrier of the first user results in H(1,k)=U(1,k)D(1,k)V^{H}(1,k). Since the first user employs the first to 25th subcarriers, the beam forming is conducted using the two OFDM symbols as s(1,1)=v(1,1)-11f(1)+v (1,1)-12g(1), s(2,1)=v(1,1)-21f(1)+v(1,1)-22g(1), s(1,2)=v(1,2)-11f(2)+v(1,2)-12g(2), s(2,2)=v(1,2)-21f(2)+v(1,2)-21g(2), . . . , s(1,25)=v(1,25)-11f(25)+v(1,25)-12g(25), s(2,25)=v(1,1)-21f(25)+v(1,25)-21g(25). Here, s(1,k) and s(2,k) represent the k-th subcarriers of the OFDM signals transmitted from the antennas 1 and 2, and v(1,k)-ij indicates an i-row and j-column element of v(1,k).

Subsequently, since the third user adopts the 26th to 40th subcarriers, the beam forming is conducted similarly as s(1,26)=v(3,26)-11f(26)+v(3,26)-12g(26), s(2,26)=v(3,26)-21f(26)+v(3,26)-22g(26), s(1,27)=v(3,27)-11f(27)+v(3,27)-12g(27), s(2,27)=v(3,27)-21f(27)+v(3,27)-21g(27), . . . , s(1,40)=v(3,40)-11f(40)+v(3,40)-12g(40), s(2,40)=v(3,40)-21f(40)+v(3,40)-21g(40).

Finally, for the fourth user, the beam forming is similarly accomplished as s(1,41)=v(4,41)-11f(41)+v(4,41)-12g(41), s(2,41)=v(4,41)-21f(41)+v(4,41)-22g(41), s(1,42)=v(4,42)-11f(42)+v(4,42)-12g(42), s(2,42)=v(4,42)-21f(42)+v(4,42)-21g(42), . . . , s(1,50)=v(4,50)-11f(50)+v(4,50)-12g(50), s(2,50)=v(4,50)-21f(50)+v(4,50)-21g(50). After the resource allocation and the beam forming are applied for the two OFDM signals in this fashion, the signals are converted by a discrete Fourier transform into time signals to be outputted.

As shown in the example, by provisionally determining the application or non-application of the beam forming for each user, it is possible to preferentially allocate radio resources to users to whom the beam forming with a high transmission characteristic is applicable, to thereby implement a highly efficient system.

Incidentally, the transmission mode controller 96 of the example employs the results from the provisional transmission mode controller 93 without modification. However, it is possible to implement a more efficient system by using the profile information in the determination of the application or non-application of the beam forming. For example, in a case wherein the resources of the reserve lines required for the feedback of the channel information as the profile information are known as in the example, it is possible, particularly in a radio communication system sharing the pertinent line and its reverse line, to keep balance therebetween in consideration of the resources.

Specifically, the amount of radio resources required for the reverse line is limited to 1.2 Mbps. In this situation, since the first, third, and fourth users respectively require 512 kbps, 512 kbps, and 256 kbps for the reverse lines, the beam forming is applied only to two users thereof. In this operation, the beam forming is applied to the first and third users having a higher required rate and is not applied to the fourth user. Resultantly, the transmission mode control signals are M-ctrl(1)=[BF], M-ctrl(2)=[N-BF], M-ctrl(3)=[BF], M-ctrl(4)=[N-BF], and M-ctrl(5)=[BF]. This makes it possible to suppress the radio resources on the reverse lines required for the feedback of the channel information.

In this situation, the transmission signal generator 71 does not conduct the singular value decomposition of the channel matrix for the fourth user. Therefore, in the creation of the transmission signals, the 41st to 50th subcarriers are s(1,41)=f(41), s(2,41)=g(41), s(1,42)=f(42), s(2,42)=g(42), . . . , s(1,50)=f(50), s(2,50)=g(50).

Also, the provisional transmission mode controller 93 of the example provisionally determines the application or non-application of the beam forming by use of the channel variation speed. However, the provisional determination may also be beforehand conducted by using more profile information items. For example, by determining a criterion for three profile information items as “the channel variation is equal to or less than ten herz” or “the required rate is equal to or more than 20 Mbps”, there remains possibility of the application of the beam forming for a larger number of users. Contrarily, by determining the criterion as “the channel variation is equal to or less than ten herz” and “the required rate is equal to or more than 20 Mbps”, it is possible to limit the application to users for whom the communication success probability is high when the beam forming is applied and the effect of the application is large.

### Example 3

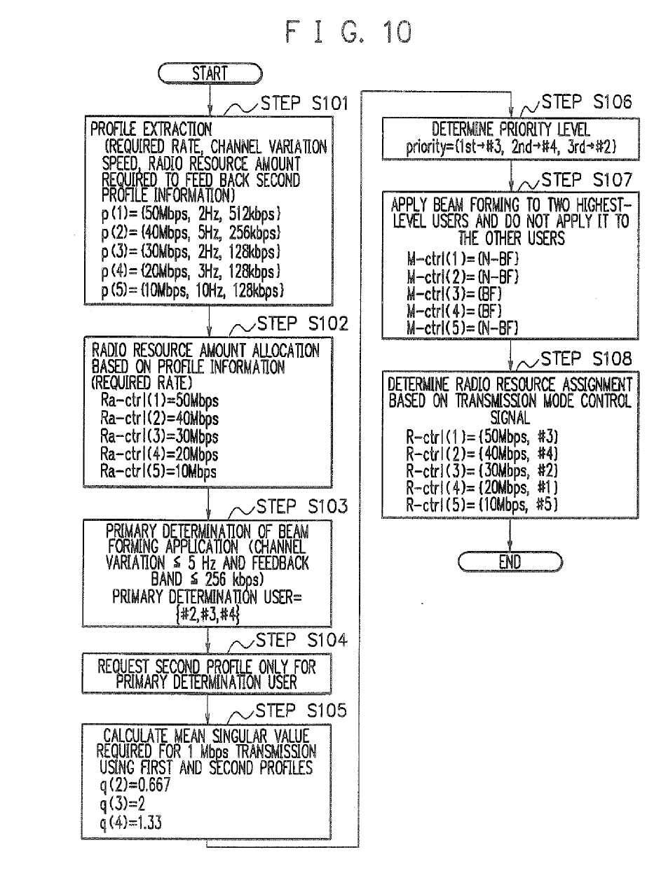

FIG. 10 is a flowchart showing processing of the transmission signal control unit 72 in accordance with the third example of the present invention.

In the example, although the transmitter is the same as that of the first example, the operation of the transmission signal control unit 72 is different from that of the first example. Therefore, the difference will be described in detail. However, although the example conducts a total of 150 Mbps transmission, the operation in the transmission signal generator unit 71 is not substantially changed, and hence description thereof will be avoided.

Referring to FIG. 10, the profile information extractor module 73 disposed in the signal controller 72 extracts profile information from the reception signals (step S101). Here, it is assumed that the profile information items are the required rate, the channel variation speed, the radio resource amount required to feed back second profile information and are respectively p(1)-[45 Mbps,2 Hz,512 kbps], p(2)=[45 Mbps,5 Hz,256 kbps], p(3)=[30 Mbps,2 Hz,128 kbps], p(4)=[5 Mbps, 3 Hz, 128 kbps], and p(5)=[15 Mbps, 10 Hz, 128 kbps].

The radio resource amount controller 74 determines, using the profile information as an input thereto, the radio resource amount to be allocated to each user to generate radio resource amount control signals (step S102). Since the sum of the required rates of the users is 150 Mbps for the overall radio resource amount of 150 Mbps, a radio resource amount equal to the required amount is allocated to each user to produce the radio resource amount control signals as Ra-ctrl(1)=[45 Mbps], Ra-ctrl(2) [45 Mbps], Ra-ctrl(3)=[30 Mbps], Ra-ctrl(4)=[15 Mbps], and Ra-ctrl(5)=[15 Mbps].

The transmission mode controller 75 uses the profile information and the radio resource amount control signals as inputs thereto to determine the application or non-application of the beam forming for each user. In the operation, the mode controller 75 determines the users to whom the beam forming is applied through the primary determination and the secondary determination. Also, it is assumed that new profile information is not obtained until the first determination is completed. Therefore, the first profile information is a required rate, a channel variation speed, and a band required to feed back the second profile information.

The mode controller 75 determines, as primary determination users, users whose channel variation speed is equal to or less than five herz and whose band attained to feed back the second profile information is equal to or less than 256 kbps (step S103). As a result, the second, third, and fourth users are the primary determination users. Through the operation, the users are selected who do not consume a large amount of radio resources on the reverse line and to whom the beam forming is applicable.

Next, a request is issued to the users for the second profile information, and only the second, third, and fourth users feed back respective channel information as the second profile information (step S104). Using the channel information thus fed back, the mode controller 75 conducts the singular value decomposition for the channel information of each user to obtain the sum of the singular values. Assume now that each user has two singular values which are D(2) [25,5], D(3)=[50,10], and D(4)=[20,0]. Therefore, assuming that the sum of two singular values of the k-th user is expressed as S(k), there are obtained S(2)=30, S(3)=60, and S(4)=20. Subsequently, a mean singular value available for the one Mbps transmission is obtained using the sum of singular values and the required rate. Assuming that this results in q, there are attained q(2)=0.667, q(3)=2, and q(4)=1.33 (step S105).

Next, the data items are sorted by assigning a priority level to users with a large value of q (step S106). This is employed to possibly increase the transmission success probability when the beam forming is applied. According to the sorted results, the beam forming is allocated to two highest-level users (step S107). Resultantly, there is obtained the secondary determination in which the beam forming is applied to the third and fourth users and the beam forming is not applied to the first, second, and fifth users. Therefore, the transmission mode control signals are M-ctrl(1)=[N-BF], M-ctrl(2)=[N-BF], M-ctrl(3)=[BF], M-ctrl(4)=[BF], and M-ctrl(5)=[BF]. Additionally, by use of the transmission mode control signals and the radio resource amount control signals as inputs thereto, the radio resource assignment controller 76 creates, as in the first example, the radio resource control signals such that the transmission time of the users to whom the beam forming is applied is earlier and the transmission time is earlier for the users having a higher channel variation speed (step S108). This results in R-ctrl(1)=[45 Mbps,#3], R-ctrl(2)=[45 Mbps,#4], R-ctrl(3)=[30 Mbps,#2], R-ctrl(4)=[15 Mbps,#1], and R-ctrl(5)=[15 Mbps,#5].

As shown in the example, the application or non-application of the beam forming is determined through the primary determination and the secondary determination to issue a request of the feedback of information only to the primary determination users requiring the second profile information, it is hence possible to determine the application or non-application of the beam forming by efficiently using the radio resource on the reverse line.

### Example 4

Next, the fourth example will be described in detail. This example differs from the third example in the operation of the transmission mode controller 75, and hence the difference will be described in detail.

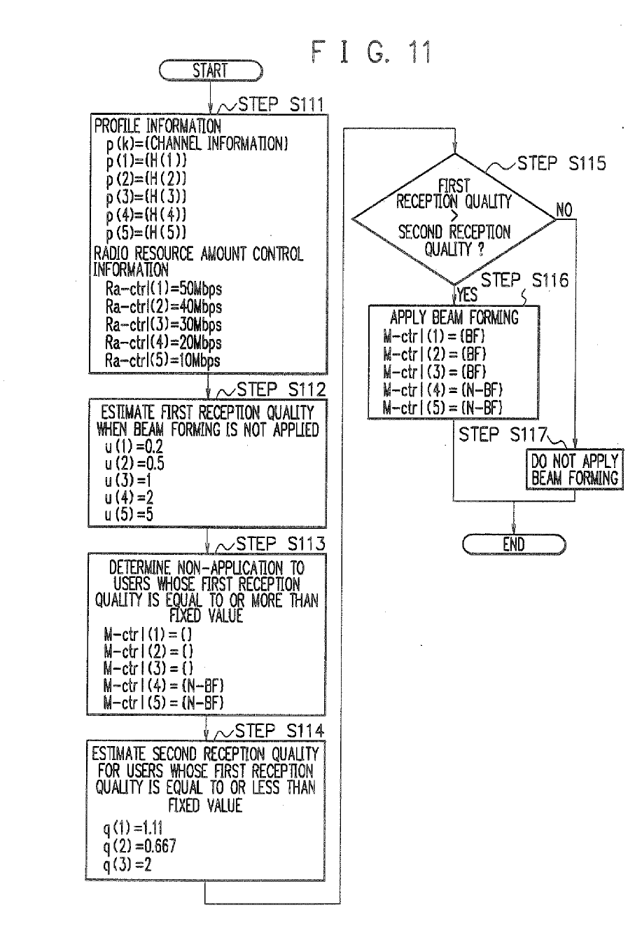

FIG. 11 is a flowchart for explaining operation of the transmission mode controller 75 in the fourth example of the present invention. It is here assumed that the profile information is channel information and a required rate of each user, i.e., p(1)=[H(1),50 Mbps], p(2)=[H(2),40 Mbps], p(3)=[H(3),30 Mbps], p(4)=[H(4),20 Mbps], and p(5)=[H(5), 10 Mbps].

The mode controller 75 receives as inputs thereto the profile information and the radio resource control signals Ra-ctrl(1)=[50 Mbps], Ra-ctrl(2)=[40 Mbps], Ra-ctrl(3)=[30 Mbps], Ra-ctrl(4)=[20 Mbps], and Ra-ctrl(5)=[10 Mbps] (step S111).

Next, the mode controller 75 estimates the first reception quality when the beam forming is not applied (step S112).

Since the channel information of each user has been acquired, the transmission mode controller 75 is capable of estimating the reception Signal-to-Noise Ratio (SNR). Assume in the transmitter 7 that the receiving method of each user is Zero Focusing (ZF) and the reception SNR of the first and second transmission signals of the k-th user are SNR(k)-1 and SNR(k)-2. Then, there are obtained SNR(k)-1=((H^{H}H)⁻¹)^{H}-11·Pt/s² and SNR(k)-2=((H^{H}H)⁻¹)^{H}-22·Pt/s². Here, H indicates the channel matrix of the k-th user and Pt represents the power of the transmission signal, and S2 indicates the mean noise power. If it is assumed that Pt/s² is fixed, ((H^{H}H)⁻¹)^{H}-11 or ((H^{H}H)⁻¹)^{H}-22 may be regarded as the reception SNR. Assume now that SNR(1)-1=5, SNR(1)-2=5, SNR(2)-1=12, SNR(2)-2=8, SNR(3)-1=10, SNR(3)-2=20, SNR(4)-1=22, SNR(4)-2=18, SNR(5)-1=20, SNR(5)-2=30. Then, the sum of SNR is obtained as SNR(1)=10, SNR(2)=20, SNR(3)=30, SNR(4)=40, and SNR(5)=50.

Next, SNR required for the one Mbps transmission is attained as the first reception quality. If the first reception quality of the k-th user is represented as u1(k), there are obtained u(1)=0.2, u(2)=0.5, u(3)=1, u(4)=2, and u(5)=5. If it is now assumed that SNR is required to be for the one Mbps transmission, it is known that the predetermined reception quality is attained without applying the beam forming to the fourth and fifth users. Therefore, it is determined that the beam forming is not applied to the fourth and fifth users (step S113).

Subsequently, for the first, second, and third users having not satisfied the predetermined first reception quality, the second reception quality u2(k) is acquired. It is here assumed that, as for the mean singular value available for the one Mbps transmission employed in the third example, the values for the second and third are the same as for the third example. If two eigen values of the first user is D(1)=[25,25], the second reception quality of each user is obtained as u2(1)=1.11, u2(2)=q(2)=0.667, and u2(3)=q(3)=2 (step S114).

Next, the first reception quality is compared with the second reception quality for each user; if the first reception quality is better than the second reception quality, it is determined that the beam forming is applied; otherwise, it is determined that the beam forming is not applied (steps S115 to S117). Now, the second reception quality exceeds the first reception quality for all users, and hence it is determined that the beam forming is applied to the first to third users. Therefore, the transmission mode controller determines the transmission mode control signals as M-ctrl(1)=[BF], M-ctrl(2)=[BF], M-ctrl(3)=[BF], M-ctrl(4)=[N-BF], and M-ctrl(5)=[N-BF].

As shown in the example, the non-application of the beam forming is beforehand determined for the users who exceed the predetermined quality without applying the beam forming, and hence the beam forming can be efficiently allocated to the users for whom the characteristic is remarkably deteriorated when the beam forming is not applied.

Incidentally, the embodiments described above are best embodiments to embody the present invention; however, it is to be understood that the present invention is not restricted by the embodiments. Consequently, the embodiments may be modified in various ways within a range in which the gist of the present invention is not changed.

### BRIEF DESCRIPTION OF DRAWINGS

[FIG. 1] is a block diagram for explaining a configuration of a radio communication system in a best embodying mode.

[FIG. 2] is a flowchart for explaining transmission processing by a transmitter of FIG. 1.

[FIG. 3] is a block diagram for explaining a configuration of a radio communication system in a second embodying mode.

[FIG. 4] is a flowchart for explaining transmission processing by a transmitter of FIG. 3.

[FIG. 5] is a block diagram for explaining a configuration of a radio communication system in a third embodying mode.

[FIG. 6] is a flowchart for explaining transmission processing by a transmitter of FIG. 5.

[FIG. 7] is a block diagram for explaining a configuration of a first embodiment of the present invention.

[FIG. 8] is a flowchart for explaining transmission processing by a transmitter of FIG. 7.

[FIG. 9] is a block diagram for explaining a configuration of a second embodiment of the present invention.

[FIG. 10] is a flowchart for explaining processing by a third embodiment of the present invention.

[FIG. 11] is a flowchart for explaining processing by a fourth embodiment of the present invention.

### DESCRIPTION OF REFERENCE NUMERALS

1, 3, 5, 7, 9 Transmitter
2 Receiver
11, 71 Transmission signal generator unit
12, 31, 51, 54, 72, 92 Transmission signal control unit
13-1 to 13-M, 13-J Antenna
14-1 to 14-M Duplexer
15, 32, 52, 77 Recording medium
33, 74 Radio resource amount control unit
34, 75 Transmission mode determining unit
35, 76 Radio resource assignment determining unit
53 Provisional transmission mode control unit
73 Profile information extracting unit
93 Provisional transmission mode control unit
94 Radio resource control unit
95 Transmission mode control unit

1. A radio communication system, characterized in that
a transmitter comprising M antennas (M is an integer equal to or more than two) to transmit signals to a receiver, comprising:
transmission signal control means for receiving as inputs thereto profile information items of N users (N is an integer equal to or more than two); determining, by use of the profile information items, a radio resource amount to be distributed to each of the N users and assignment thereof as well as application or non-application of beam forming; and creating and outputting radio resource control signals indicating the radio resource amount to be distributed and the assignment thereof and transmission mode control signals indicating a result of the application or non-application; and
transmission signal creating means for receiving as inputs thereto transmission data items of the N users, the radio resource control signals, and the transmission mode control signals; allocating radio resources to N1 users (N1 is an integer equal to or more than one and equal to less than N) to which radio resources are allocated on the basis of the radio resource control signals, creating the transmission signals using the transmission data items by applying the beam forming for N2 users (N2 is an integer equal to or more than zero and equal to less than N1) for whom the transmission mode control signals indicate the application, creating the transmission signals using the transmission data items without applying the beam forming for N3 users (N3 is an integer equal to or more than zero and equal to less than N1 and N2+N3=N1) for whom the transmission mode control signals indicate the non-application, and outputting the transmission signals thus created.

2. The radio communication system in accordance with claim 1, wherein
the transmission signal control means determines, by use of the profile information items, a radio resource amount to be distributed to each of the N users, creates radio resource amount control signals, determines application or non-application of beam forming for the N1 users on the basis of the profile information items and the radio resource amount control signals, creates the transmission mode control signals, determines assignment of a radio resource to be distributed to each of the N users by use of the radio resource amount control signals and the transmission mode control signals, and thereby produces the radio resource control signals.

3. The radio communication system in accordance with claim 1, wherein
the transmission signal control means provisionally determines, by use of the profile information items, application or non-application of beam forming for each of the N users; generates provisional transmission mode control signals, determines, by use of the profile information items and the provisional transmission mode control signals, a radio resource amount to be distributed to each of the N users and assignment thereof as well as application or non-application of beam forming to the N1 users, and generates the radio resource control signals and the transmission mode control signals.

4. The radio communication system in accordance with claim 3, wherein
the transmission signal control means determines, by use of the profile information items and the provisional transmission mode control signals, a radio resource amount to be distributed to each of the N users and assignment thereof; generates radio resource control signals, receives as inputs thereto the profile information items and the radio resource control signals, determines application or non-application of beam forming for the N1 users, and generates the transmission mode control signals.

5. The radio communication system in accordance with claim 3, wherein
the transmission signal control means determines, by use of the profile information items and the provisional transmission mode control signals, a radio resource amount to be distributed to each of the N users and assignment thereof; generates radio resource control signals, receives as inputs thereto the radio resource control signals and the provisional transmission mode control signals; and generates the provisional transmission mode control signals for the N1 users, as the transmission mode control signals.

6. The radio communication system in accordance with claim 1, wherein
the transmission signal control means determines assignment of radio resources such that signal transmission points of time of the N2 users are earlier than signal transmission points of time of the N3 users and generates radio resource control signals.

7. The radio communication system in accordance with claim 2, wherein
the transmission signal control means estimates, in the determination of the application or non-application of the beam forming for the N1 users, first reception quality when the beam forming is not applied, by using the profile information items; determines the non-application of the beam forming if the first reception quality exceeds a predetermined value; estimates, if the first reception quality does not exceed the predetermined value, second reception quality when the beam forming is applied; determines the application of the beam forming if the second reception quality exceeds the first reception quality, determines the non-application of the beam forming if the second reception quality does not exceed the first reception quality, and generates the transmission mode control signals.

8. The radio communication system in accordance with claim 2, wherein
the transmission signal control means conducts, in the determination of the application or non-application of the beam forming for the N1 users by using the profile information items and the radio resource amount control signals, the determination through primary determination and secondary determination; carries out the primary determination using the first profile information items attained by when the second determination is started, determines the application or non-application of the beam forming by accomplishing the secondary determination by use of second profile information items requiring only the primary determination users determined in the primary determination to conduct the feedback or by use of only the second profile or both of the first and second profiles; and thereby generating the transmission mode control signals.

9. The radio communication system in accordance with claim 8, characterized in that
the transmission signal control means determines, as the primary determination users, users having K elements (K is an integer equal to or more than one) included in the first profile information items, the K elements including K1 elements (K1 is an integer equal to or more than one and equal to or less than k) exceeding a predetermined reference value.

10. The radio communication system in accordance with claim 8, characterized in that
the transmission signal control means determines, as the primary determination users, users having K elements included in the first profile information items, the K elements including K2 elements (K2 is an integer equal to or more than one and equal to or less than k) all of which exceeding a predetermined reference value.

11. The radio communication system in accordance with claim 8, characterized in that
the transmission signal control means adopts, as the first profile information, a radio resource amount necessary for the feedback of the second profile information.

12. The radio communication system in accordance with claim 8, characterized in that
the transmission signal control means determines priority levels of the primary determination users by use of L1 elements selected from L elements included in the second profile information (L is an integer equal to or more than one; L1 is an integer equal to or more than one and equal to or less than L) and determines, as the secondary determination, users having a priority level exceeding a predetermined priority level.

13. The radio communication system in accordance with claim 3, wherein
the transmission signal control means estimates, in the provisional determination of the application or non-application of beam forming for each of the N users by use of the profile information items, first reception quality when the beam forming is not applied; provisionally determines the non-application of beam forming if the first reception quality exceeds a predetermined value; estimates, if the first reception quality does not exceed the predetermined value, second reception quality when the beam forming is applied; provisionally determines the application of beam forming if the second reception quality exceeds the first reception quality; provisionally determines the non-application of beam forming if the second reception quality does not exceed the first reception quality; and thereby produces the provisional transmission mode control signals.

14. The radio communication system in accordance with claim 3, wherein
the transmission signal control means provisionally determines, in the provisional determination of the application or non-application of beam forming for each of the N users by use of the profile information items, the application of beam forming for users whose P elements (P is an integer equal to or more than one) included in the profile information items include P1 elements (P is an integer equal to or more than one and equal to or less than P) exceeding a predetermined reference value; provisionally determines the non-application for the other users, and thereby produces the provisional transmission mode control signals.

15. The radio communication system in accordance with claim 3, wherein
the transmission signal control means provisionally determines, in the provisional determination of the application or non-application of beam forming for each of the N users by use of the profile information items, the application of beam forming for users whose P elements (P is an integer equal to or more than one) included in the profile information items include a predetermined number P2 elements (P2 is an integer equal to or more than one and equal to or less than P) all of which exceeding a reference value; provisionally determines the non-application of beam forming for the other users, and thereby produces the provisional transmission mode control signals.

16. A transmitter comprising M antennas (M is an integer equal to or more than two) to transmit signals to a receiver, characterized by comprising:
transmission signal control means for receiving as inputs thereto profile information items of N users (N is an integer equal to or more than two); determining, by use of the profile information items, a radio resource amount to be distributed to each of the N users and assignment thereof as well as application or non-application of beam forming; and creating and outputting radio resource control signals indicating the radio resource amount to be distributed and the assignment thereof and transmission mode control signals indicating a result of the application or non-application; and
transmission signal creating means for receiving as inputs thereto transmission data items of the N users, the radio resource control signals, and the transmission mode control signals; allocating radio resources to N1 users (N1 is an integer equal to or more than one and equal to less than N) to which radio resources are allocated on the basis of the radio resource control signals, creating the transmission signals using the transmission data items by applying the beam forming for N2 users (N2 is an integer equal to or more than zero and equal to less than N1) for whom the transmission mode control signals indicate the application, creating the transmission signals using the transmission data items without applying the beam forming for N3 users (N3 is an integer equal to or more than zero and equal to less than N1 and N2+N3=N1) for whom the transmission mode control signals indicate the non-application, and outputting the transmission signals thus created.

17. The transmitter in accordance with claim 16, wherein
the transmission signal control means determines, by use of the profile information items, a radio resource amount to be distributed to each of the N users, creates radio resource amount control signals, determines application or non-application of beam forming for the N1 on the basis of the profile information items and the radio resource amount control signals, creates the transmission mode control signals, determines assignment of a radio resource to be distributed to each of the N users by use of the radio resource amount control signals and the transmission mode control signals, and thereby produces the radio resource control signals.

18. The transmitter in accordance with claim 16, wherein
the transmission signal control means provisionally determines, by use of the profile information items, application or non-application of beam forming for each of the N users; generates provisional transmission mode control signals, determines, by use of the profile information items and the provisional transmission mode control signals, a radio resource amount to be distributed to each of the N users and assignment thereof as well as application or non-application of beam forming to the N1 users, and generates the radio resource control signals and the transmission mode control signals.

19. The transmitter in accordance with claim 18, wherein
the transmission signal control means determines, by use of the profile information items and the provisional transmission mode control signals, a radio resource amount to be distributed to each of the N users and assignment thereof, generates radio resource control signals, receives as inputs thereto the profile information items and the radio resource control signals, determines application or non-application of beam forming for the N1 users, and generates the transmission mode control signals.

20. The transmitter in accordance with claim 18, wherein
the transmission signal control means determines, by use of the profile information items and the provisional transmission mode control signals, a radio resource amount to be distributed to each of the N users and assignment thereof; generates radio resource control signals, receives as inputs thereto the radio resource control signals and the provisional transmission mode control signals; and generates the provisional transmission mode control signals for the N1 users, as the transmission mode control signals.

21. The transmitter in accordance with claim 16, wherein
the transmission signal control means determines assignment of radio resources such that signal transmission points of time of the N2 users are earlier than signal transmission points of time of the N3 users and generates radio resource control signals.

22. The transmitter in accordance with claim 17, wherein
the transmission signal control means estimates, in the determination of the application or non-application of the beam forming for the N1 users, first reception quality when the beam forming is not applied, by using the profile information items; determines the non-application of the beam forming if the first reception quality exceeds a predetermined value; estimates, if the first reception quality does not exceed the predetermined value, second reception quality when the beam forming is applied; determines the application of the beam forming if the second reception quality exceeds the first reception quality, determines the non-application of the beam forming if the second reception quality does not exceed the first reception quality, and generates the transmission mode control signals.

23. The transmitter in accordance with claim 17, wherein
the transmission signal control means conducts, in the determination of the application or non-application of the beam forming for the N1 users by using the profile information items and the radio resource amount control signals, the determination through primary determination and secondary determination; carries out the primary determination using the first profile information items attained by when the second determination is started, determines the application or non-application of the beam forming by accomplishing the secondary determination by use of second profile information items requiring only the primary determination users determined in the primary determination to conduct the feedback or by use of only the second profile or both of the first and second profiles; and thereby generating the transmission mode control signals.

24. The transmitter in accordance with claim 23, characterized in that
the transmission signal control means determines, as the primary determination users, users having K elements (K is an integer equal to or more than one) included in the first profile information items, the K elements including K1 elements (K1 is an integer equal to or more than one and equal to or less than k) exceeding a predetermined reference value.

25. The transmitter in accordance with claim 23, characterized in that
the transmission signal control means determines, as the primary determination users, users having K elements included in the first profile information items, the K elements including K2 elements (K2 is an integer equal to or more than one and equal to or less than k) all of which exceeding a predetermined reference value.

26. The transmitter in accordance with claim 23, characterized in that
the transmission signal control means adopts, as the first profile information, a radio resource amount necessary for the feedback of the second profile information.

27. The transmitter in accordance with claim 23, characterized in that
the transmission signal control means determines priority levels of the primary determination users by use of L1 elements selected from L elements included in the second profile information (L is an integer equal to or more than one; L1 is an integer equal to or more than one and equal to or less than L) and determines, as the secondary determination, users having a priority level exceeding a predetermined priority level.

28. The transmitter in accordance with claim 18, wherein
the transmission signal control means estimates, in the provisional determination of the application or non-application of beam forming for each of the N users by use of the profile information items, first reception quality when the beam forming is not applied; provisionally determines the non-application of beam forming if the first reception quality exceeds a predetermined value; estimates, if the first reception quality does not exceed the predetermined value, second reception quality when the beam forming is applied; provisionally determines the application of beam forming if the second reception quality exceeds the first reception quality; provisionally determines the non-application of beam forming if the second reception quality does not exceed the first reception quality; and thereby produces the provisional transmission mode control signals.

29. The transmitter in accordance with claim 18, wherein
the transmission signal control means provisionally determines, in the provisional determination of the application or non-application of beam forming for each of the N users by use of the profile information items, the application of beam forming for users whose P elements (P is an integer equal to or more than one) included in the profile information items include P1 elements (P is an integer equal to or more than one and equal to or less than P) exceeding a predetermined reference value; provisionally determines the non-application for the other users, and thereby produces the provisional transmission mode control signals.

30. The transmitter in accordance with claim 18, wherein
the transmission signal control means provisionally determines, in the provisional determination of the application or non-application of beam forming for each of the N users by use of the profile information items, the application of beam forming for users whose P elements (P is an integer equal to or more than one) included in the profile information items include a predetermined number P2 elements (P2 is an integer equal to or more than one and equal to or less than P) all of which exceeding a reference value; provisionally determines the non-application of beam forming for the other users, and thereby produces the provisional transmission mode control signals.

31. A transmission method for a transmitter comprising M antennas (M is an integer equal to or more than two) to transmit signals to a receiver, characterized by comprising:
a transmission signal control step of receiving as inputs thereto profile information items of N users (N is an integer equal to or more than two); determining, by use of the profile information items, a radio resource amount to be distributed to each of the N users and assignment thereof as well as application or non-application of beam forming; and creating and outputting radio resource control signals indicating the radio resource amount to be distributed and the assignment thereof and transmission mode control signals indicating a result of the application or non-application; and
a transmission signal creating step of receiving as inputs thereto transmission data items of the N users, the radio resource control signals, and the transmission mode control signals; allocating radio resources to N1 users (N1 is an integer equal to or more than one and equal to less than N) to which radio resources are allocated on the basis of the radio resource control signals, creating the transmission signals using the transmission data items by applying the beam forming for N2 users (N2 is an integer equal to or more than zero and equal to less than N1) for whom the transmission mode control signals indicate the application, creating the transmission signals using the transmission data items without applying the beam forming for N3 users (N3 is an integer equal to or more than zero and equal to less than N1 and N2+N3=N1) for whom the transmission mode control signals indicate the non-application, and outputting the transmission signals thus created.

32. The transmission method in accordance with claim 31, wherein
the transmission signal control step determines, by use of the profile information items, a radio resource amount to be distributed to each of the N users, creates radio resource amount control signals, determines application or non-application of beam forming for the N1 users on the basis of the profile information items and the radio resource amount control signals, creates the transmission mode control signals, determines assignment of a radio resource to be distributed to each of the N users by use of the radio resource amount control signals and the transmission mode control signals, and thereby produces the radio resource control signals.

33. The transmission method in accordance with claim 31, wherein
the transmission signal control step provisionally determines, by use of the profile information items, application or non-application of beam forming for each of the N users; generates provisional transmission mode control signals, determines, by use of the profile information items and the provisional transmission mode control signals, a radio resource amount to be distributed to each of the N users and assignment thereof as well as application or non-application of beam forming to the N1 users, and generates the radio resource control signals and the transmission mode control signals.

34. The transmission method in accordance with claim 33, wherein
the transmission signal control step determines, by use of the profile information items and the provisional transmission mode control signals, a radio resource amount to be distributed to each of the N users and assignment thereof; generates radio resource control signals, receives as inputs thereto the profile information items and the radio resource control signals, determines application or non-application of beam forming for the N1 users, and generates the transmission mode control signals.

35. The transmission method in accordance with claim 33, wherein
the transmission signal control step determines, by use of the profile information items and the provisional transmission mode control signals, a radio resource amount to be distributed to each of the N users and assignment thereof; generates radio resource control signals, receives as inputs thereto the radio resource control signals and the provisional transmission mode control signals; and generates the provisional transmission mode control signals for the N1 users, as the transmission mode control signals.

36. The transmission method in accordance with claim 31, wherein
the transmission signal control step determines assignment of radio resources such that signal transmission points of time of the N2 users are earlier than signal transmission points of time of the N3 users and generates radio resource control signals.

37. The transmission method in accordance with claim 32, wherein
the transmission signal control step estimates, in the determination of the application or non-application of the beam forming for the N1 users, first reception quality when the beam forming is not applied, by using the profile information items; determines the non-application of the beam forming if the first reception quality exceeds a predetermined value; estimates, if the first reception quality does not exceed the predetermined value, second reception quality when the beam forming is applied; determines the application of the beam forming if the second reception quality exceeds the first reception quality, determines the non-application of the beam forming if the second reception quality does not exceed the first reception quality, and generates the transmission mode control signals.

38. The transmission method in accordance with claim 32, wherein
the transmission signal control step conducts, in the determination of the application or non-application of the beam forming for the N1 users by using the profile information items and the radio resource amount control signals, the determination through primary determination and secondary determination; carries out the primary determination using the first profile information items attained by when the second determination is started, determines the application or non-application of the beam forming by accomplishing the secondary determination by use of second profile information items requiring only the primary determination users determined in the primary determination to conduct the feedback or by use of only the second profile or both of the first and second profiles; and thereby generating the transmission mode control signals.

39. The transmission method in accordance with claim 38, characterized in that
the transmission signal control step determines, as the primary determination users, users having K elements (K is an integer equal to or more than one) included in the first profile information items, the K elements including K1 elements (K1 is an integer equal to or more than one and equal to or less than k) exceeding a predetermined reference value.

40. The transmission method in accordance with claim 38, characterized in that
the transmission signal control step determines, as the primary determination users, users having K elements included in the first profile information items, the K elements including K2 elements (K2 is an integer equal to or more than one and equal to or less than k) all of which exceeding a predetermined reference value.

41. The transmission method in accordance with claim 38, characterized in that
the transmission signal control step adopts, as the first profile information, a radio resource amount necessary for the feedback of the second profile information.

42. The transmission method in accordance with claim 38, characterized in that
the transmission signal control step determines priority levels of the primary determination users by use of L1 elements selected from L elements included in the second profile information (L is an integer equal to or more than one; L1 is an integer equal to or more than one and equal to or less than L) and determines, as the secondary determination, users having a priority level exceeding a predetermined priority level.

43. The transmission method in accordance with claim 33, wherein
the transmission signal control step estimates, in the provisional determination of the application or non-application of beam forming for each of the N users by use of the profile information items, first reception quality when the beam forming is not applied; provisionally determines the non-application of beam forming if the first reception quality exceeds a predetermined value; estimates, if the first reception quality does not exceed the predetermined value, second reception quality when the beam forming is applied; provisionally determines the application of beam forming if the second reception quality exceeds the first reception quality; provisionally determines the non-application of beam forming if the second reception quality does not exceed the first reception quality; and thereby produces the provisional transmission mode control signals.

44. The transmission method in accordance with claim 33, wherein
the transmission signal control step provisionally determines, in the provisional determination of the application or non-application of beam forming for each of the N users by use of the profile information items, the application of beam forming for users whose P elements (P is an integer equal to or more than one) included in the profile information items include P1 elements (P is an integer equal to or more than one and equal to or less than P) exceeding a predetermined reference value; provisionally determines the non-application for the other users, and thereby produces the provisional transmission mode control signals.

45. The transmission method in accordance with claim 33, wherein
the transmission signal control step provisionally determines, in the provisional determination of the application or non-application of beam forming for each of the N users by use of the profile information items, the application of beam forming for users whose P elements (P is an integer equal to or more than one) included in the profile information items include a predetermined number P2 elements (P2 is an integer equal to or more than one and equal to or less than P) all of which exceeding a reference value; provisionally determines the non-application of beam forming for the other users, and thereby produces the provisional transmission mode control signals.

46. A program of a transmission method for a transmitter comprising M antennas (M is an integer equal to or more than two) to transmit signals to a receiver, the program causing a computer to perform
transmission signal control processing for receiving as inputs thereto profile information items of N users (N is an integer equal to or more than two); determining, by use of the profile information items, a radio resource amount to be distributed to each of the N users and assignment thereof as well as application or non-application of beam forming; and creating and outputting radio resource control signals indicating the radio resource amount to be distributed and the assignment thereof and transmission mode control signals indicating a result of the application or non-application; and
transmission signal creating processing for receiving as inputs thereto transmission data items of the N users, the radio resource control signals, and the transmission mode control signals; allocating radio resources to N1 users (N1 is an integer equal to or more than one and equal to less than N) to which radio resources are allocated on the basis of the radio resource control signals, creating the transmission signals using the transmission data items by applying the beam forming for N2 users (N2 is an integer equal to or more than zero and equal to less than N1) for whom the transmission mode control signals indicate the application, creating the transmission signals using the transmission data items without applying the beam forming for N3 users (N3 is an integer equal to or more than zero and equal to less than N1 and N2+N3=N1) for whom the transmission mode control signals indicate the non-application, and outputting the transmission signals thus created.

47. A recording medium for recording the program of claim 46.
